(19) United States
(12) Patent Application Publication
(10) Pub. No.: US 2021/0327281 A1
(43) Pub. Date: Oct. 21, 2021

(54) CONVOY VEHICLE DETERMINATION DEVICE, VEHICLE, AND CONVOY VEHICLE DETERMINATION METHOD

(71) Applicant: Isuzu Motors Limited, Tokyo (JP)

(72) Inventor: Yasuyuki MISHIMA, Fujisawa-shi, Kanagawa (JP)

(73) Assignee: Isuzu Motors Limited, Tokyo (JP)

(21) Appl. No.: 17/271,616

(22) PCT Filed: Aug. 30, 2019
(86) PCT No.: PCT/JP2019/034293

§ 371 Date: Feb. 26, 2021

(30) Foreign Application Priority Data
Aug. 31, 2018 (JP) 2018-163378

(51) Int. Cl. G08G 1/00; G08G 1/017; G05D 1/02; H04W 4/46

(52) U.S. Cl. CPC G08G 1/22; G08G 1/017; G05D 2201/0213; H04W 4/46; G05D 1/0295

(57) ABSTRACT

This convoy vehicle determination device can efficiently form convoys. The convoy vehicle determination device, which determines a second vehicle for forming a convoy with a first vehicle, is provided with a storage unit which stores characteristic information of a third vehicle different from the first vehicle, and a vehicle detection unit which, from peripheral vehicles present in the periphery of the first vehicle, detects, as candidates for a second vehicle, vehicles having the same characteristic information as the characteristic information stored in the storage unit. For example, in the storage unit, characteristic information of the third vehicle is stored associated with vehicle information about the first vehicle.

### TECHNICAL FIELD

The present disclosure relates to a platoon vehicle determination apparatus, a vehicle and a platoon vehicle determination method.

### BACKGROUND ART

A technique is known in which a platoon of a plurality of vehicles is organized by controlling a following vehicle to follow a vehicle ahead. Platooning achieves advantageous effects such as improvement in fuel efficiency, reduction in traffic congestion, and reduction in operation cost.

As a technique for organizing a platoon, PTL 1 discloses a vehicle group formation control apparatus including a reception section configured to receive vehicle information from another vehicle or another vehicle group, a comparison section configured to compare the received vehicle information with the own vehicle information, and a selection section configured to select a vehicle or a vehicle group to be organized into a platoon from the comparison result, for example.

### CITATION LIST

### Patent Literature

PTL 1

Japanese Patent Application Laid-Open No. H10-261195

### SUMMARY OF INVENTION

### Technical Problem

However, in the vehicle group formation control apparatus disclosed in PTL 1, it is necessary to select the vehicle to be organized into a platoon for all of other vehicles or other vehicle groups, and consequently the platoon cannot be efficiently organized.

An object of the present disclosure is to provide a platoon vehicle determination apparatus, a vehicle and a platoon vehicle determination method that can efficiently organize a platoon.

### Solution to Problem

To achieve the above-mentioned object, a platoon vehicle determination apparatus of an embodiment of the present disclosure is configured to determine a second vehicle to be organized into a platoon with a first vehicle, the platoon vehicle determination apparatus including: a storage section configured to store unique information of a third vehicle different from the first vehicle; and a vehicle detection section configured to detect, as a candidate for the second vehicle, a vehicle having a same unique information as the unique information stored in the storage section from among surrounding vehicles in a region around the first vehicle.

In addition, a vehicle of an embodiment of the present disclosure includes the above-mentioned platoon vehicle determination apparatus.

In addition, a platoon vehicle determination method of an embodiment of the present disclosure is a method of determining a second vehicle to be organized into a platoon with a first vehicle, the method including: storing unique information of a third vehicle different from the first vehicle; and detecting, as a candidate for the second vehicle, a vehicle having a same unique information as the unique information that is stored from among surrounding vehicles in a region around the first vehicle.

### Advantageous Effects of Invention

According to the present disclosure, a platoon can be efficiently organized.

### BRIEF DESCRIPTION OF DRAWINGS

FIG. 1 is a control block diagram schematically illustrating a configuration of a platoon vehicle determination apparatus according to an embodiment of the present disclosure;

FIG. 2 is an explanatory diagram of a table in which unique information of a third vehicle is stored in association with vehicle information of a first vehicle; and

FIG. 3 is a flowchart of an exemplary operation of the platoon vehicle determination apparatus of the embodiment.

### DESCRIPTION OF EMBODIMENTS

An embodiment of the present disclosure is described below with reference to the drawings.

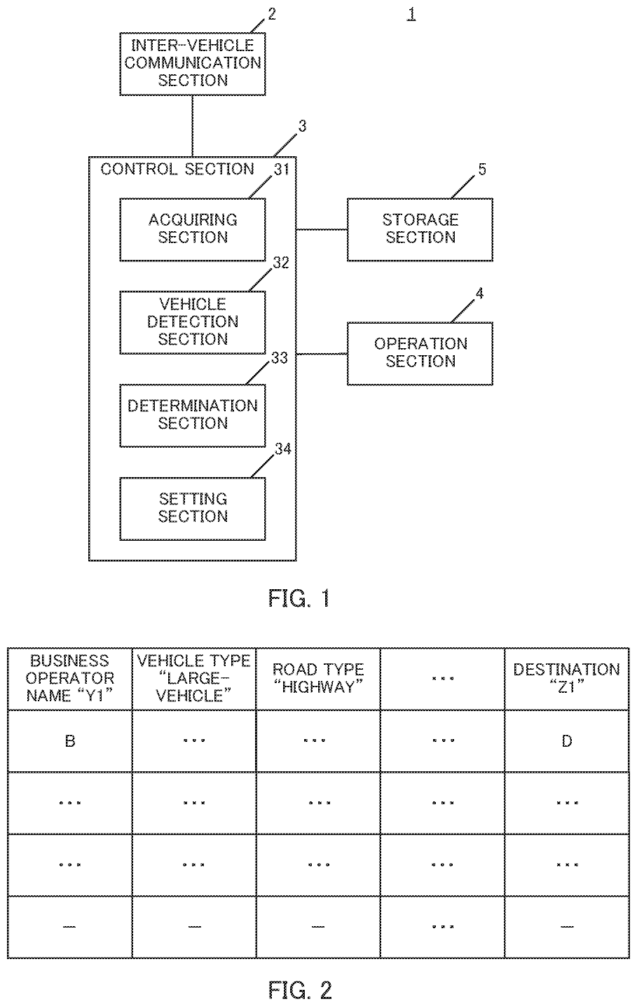

FIG. 1 is a control block diagram schematically illustrating a configuration of platoon vehicle determination apparatus 1 according to the embodiment of the present disclosure. Platoon vehicle determination apparatus 1 detects candidates for a second vehicle to be organized into a platoon with the first vehicle from among surrounding vehicles in a region around the first vehicle, and determines the second vehicle from among the detected candidates for the second vehicle. Platoon vehicle determination apparatus 1 includes inter-vehicle communication section 2, control section 3, operation section 4, and storage section 5. Platoon vehicle determination apparatus 1 is provided in each vehicle. In the following description, platoon vehicle determination apparatus 1 is provided in the first vehicle.

Storage section 5 is composed of a nonvolatile memory (so-called flash memory) or a hard disk drive, for example. In storage section 5, unique information of a third vehicle that is highly likely to be organized into a platoon with the first vehicle is stored. The unique information of the third vehicle that is highly likely to be organized into a platoon with the first vehicle is, for example, unique information of the third vehicle having the same business operator name as the first vehicle, or unique information of the third vehicle that has been organized into a platoon with the first vehicle in the past. In storage section 5, a table in which the unique information of the third vehicle is stored in association with the vehicle information of the first vehicle (see FIG. 2). Here, unique information of a vehicle is information for identifying a vehicle such as a vehicle identification number and license plate information.

Inter-vehicle communication section 2 is a communication apparatus configured to use a wireless radio wave of a predetermined frequency band and transmit and receive it between vehicles, and exchanges a variety of information related to the vehicle between the vehicles. Inter-vehicle communication section 2 receives unique information of surrounding vehicles in a region around the first vehicle. Inter-vehicle communication section 2 receives vehicle information related to a candidate for the second vehicle. Here, the unique information of surrounding vehicles is unique information assigned to surrounding vehicles. In addition, the vehicle information of a candidate for the second vehicle is information that serves as a reference when determination section 33 (described later) determines the second vehicle.

The vehicle information includes, for example, the business operator name, the vehicle type, the road type, the destination, the transit point, the travelling speed, the vehicle weight, the specification, the start time, the end time, and the effective period. The business operator name may be a formal name, an abbreviation, or a business operator code. Examples of the vehicle type include standard, medium, large, and extra-large vehicles. Examples of the road type include a highway and an ordinary road. Examples of the travelling speed include a predetermined speed maintained in auto-cruising. Examples of the specification include the structure, apparatuses and performance of a vehicle. The start time is a start time of a time period when a platoon can be organized. The end time is an end time in a time period when a platoon can be organized. The effective period is a period when a platoon can be organized.

Control section 3 is composed of a microcomputer including a central processing unit (CPU), a read only memory (ROM), a random access memory (RAM), an input interface, and an output interface. The CPU reads a program corresponding to the processing from the ROM and loads it into the RAM, and, performs a centralized control of operations of each block and the like in cooperation with the loaded program. Note that in the present embodiment, control section 3 has functions of acquiring section 31, vehicle detection section 32, determination section 33, and setting section 34. Note that these functions may be included in an electric control unit (ECU), which is an apparatus that uses an electronic circuit to control each system in a vehicle. In addition, some or all of these functions may be provided separately from the ECU.

Operation section 4 is composed of a liquid crystal display (LCD) with a touch panel, for example. The LCD displays various types of images including an input key in accordance with a display control signal input from control section 3. Operation section 4 receives an operation on the input key by the user and outputs an operation signal to control section 3. Here, the user includes a driver of the first vehicle, a manager who manages the first vehicle, and a third party who supports the platooning of the first vehicle.

FIG. 2 is an explanatory diagram of a table in which unique information of the third vehicle is stored in association with vehicle information of the first vehicle. As illustrated in FIG. 2, the unique information is indicated in the column direction in the table. In addition, the vehicle information is indicated in the row direction in the table. In storage section 5, a table in which unique information of the third vehicle is stored in association with vehicle information of the first vehicle is stored. The unique information of the third vehicle stored in the table illustrated in FIG. 2 is unique information of the third vehicle that has been organized into a platoon with the first vehicle in the past. In addition, the vehicle information of the first vehicle associated with the unique information of the third vehicle is vehicle information that has been used as a reference for determination when organizing a platoon. Note that in FIG. 2, “. . . ” means omission of stored unique information. In addition, in FIG. 2, “−” means that no unique information is stored.

The unique information of the third vehicle stored in the table is set (added, changed, or deleted) through an operation by the user. For example, when operation section 4 is operated by a driver, setting section 34 sets unique information of the third vehicle on the basis of an operation signal from operation section 4.

In addition, the vehicle information is set (added (selected), changed, or deleted) through an operation by the user. For example, when an off button displayed on the LCD is operated by the driver, control section 3 sets the vehicle information corresponding to the button displayed on the LCD. In addition, for example, when setting of vehicle information is requested from a business operator to platoon vehicle determination apparatus 1 of the first vehicle through the Internet, control section 3 receives the request of the setting and sets the vehicle information.

Acquiring section 31 acquires the unique information of surrounding vehicles in a region around the first vehicle. From among surrounding vehicles, vehicle detection section 32 detects, as a candidate for the second vehicle, a vehicle having the same unique information as the unique information of the third vehicle stored in storage section 5.

Acquiring section 31 acquires the vehicle information of the candidate for the second vehicle detected by vehicle detection section 32. On the basis of the vehicle information of the candidate for the second vehicle acquired by acquiring section 31 and the vehicle information of the first vehicle associated with the unique information of the third vehicle, determination section 33 determines whether the candidate for the second vehicle is the second vehicle to be organized into the platoon with the first vehicle.

Next, platoon vehicle determination apparatus 1 is described with a specific example. Here, the business operator name of the first vehicle is referred to as “Y1”. The destination of the first vehicle is referred to as “Z1”. As illustrated in FIG. 2, unique information B stored in the table is associated with business operator name “Y1”. In addition, unique information D stored in the table is associated with destination “Z1”. Note that in the following description, the third vehicles assigned to unique information B and D stored in the table illustrated in FIG. 2 are referred to as third vehicle B and third vehicle D, respectively.

First, a candidate for the second vehicle is detected from among surrounding vehicles in a region around the first vehicle. Therefore, inter-vehicle communication section 2 receives unique information of surrounding vehicles. Here, inter-vehicle communication section 2 receives unique information of surrounding vehicles B, C, D, . . . , and K.

From among surrounding vehicles, vehicle detection section 32 detects, as a candidate for the second vehicle, vehicles B and D having the same unique information as the unique information of the third vehicles B and D stored in storage section 5 (see the table illustrated in FIG. 2).

However, the vehicle information of the candidate for the second vehicle (vehicles B and D) detected in this manner may not always be the same as the vehicle information of the first vehicle. In view of this, inter-vehicle communication section 2 receives the vehicle information of vehicle B. Acquiring section 31 acquires the business operator name “Y1” and the destination “Z2” of vehicle B. In addition, inter-vehicle communication section 2 receives the vehicle information of vehicle D. Acquiring section 31 acquires the business operator name “Y2” and the destination “Z1” of vehicle D. Note that the vehicle information of the candidate for the second vehicle acquired by acquiring section 31 and the vehicle information stored in the table illustrated in FIG. 2 may differ from each other in destination and the like, for example. However, assume here that they have no difference for the sake of simplicity of description. In addition, assume here that the destination is vehicle information used as a reference for determining whether the candidate for the second vehicle is the second vehicle to be organized into a platoon with the first vehicle. Setting section 34 sets the vehicle information on the basis of the operation signal of operation section 4.

Determination section 33 determines that vehicle D is the second vehicle to be organized into a platoon with the first vehicle on the basis of the destination “Z1” of the candidate for the second vehicle (vehicle D). Vehicle D is determined to be the second vehicle to be organized into a platoon with the first vehicle because the destination “Z1” of vehicle D and the destination “Z1” of first vehicle match each other. On the other hand, on the basis of the destination “Z2” of the candidate for the second vehicle (vehicle B), determination section 33 determines that vehicle B is not the second vehicle to be organized into a platoon with the first vehicle. The reason for this is that the destination “Z2” of vehicle B is not the destination “Z1” of the first vehicle.

Note that while the vehicle information used as the reference of the determination is the destination, the present disclosure is not limited to this. It may be the vehicle information (for example, a business operator name). In this case, the vehicle information used as the reference of the determination is set (changed, added, or deleted) by an operation of the user. In addition, the vehicle information used as the reference of the determination may be a plurality of pieces of information such as destination and business operator name, for example. In this case, setting section 34 sets multiple pieces of vehicle information on the basis of the operation signal of operation section 4.

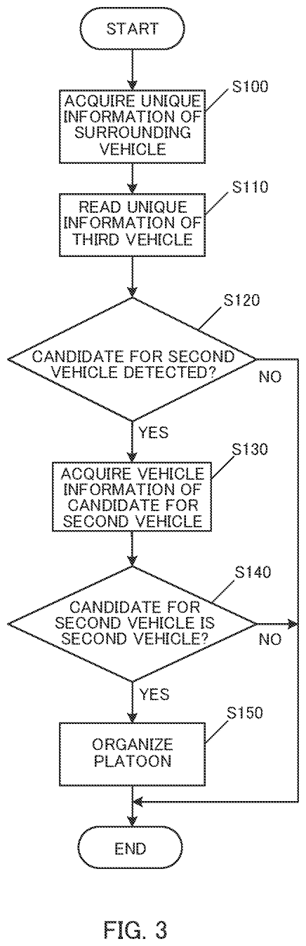

Next, a platoon vehicle determination process operation according to the embodiment of the present disclosure is described with reference to FIG. 3. FIG. 3 is a flowchart of an exemplary platoon vehicle determination process operation in the present embodiment. The processing of the flowchart is started in response to an operation on operation section 4 by the user. Note that in storage section 5, the unique information of the third vehicle is stored in association with the vehicle information of the first vehicle.

First, at step S100 illustrated in FIG. 3, acquiring section 31 acquires unique information of surrounding vehicles in a region around the first vehicle.

Next, at step S110, control section 3 reads the unique information of the third vehicle stored in storage section 5.

Next, at step S120, control section 3 determines whether a vehicle having the same unique information as the unique information stored in storage section 5 has been detected as a candidate for the second vehicle from among surrounding vehicles. When a candidate for the second vehicle has been detected (step S120: YES), the process is advanced to step S130. When a candidate for the second vehicle has not been detected (step S120: NO), the process is terminated.

At step S130, acquiring section 31 acquires the vehicle information of the candidate for the second vehicle.

Next, at step S140, determination section 33 determines whether the candidate for the second vehicle is the second vehicle to be organized into a platoon with the first vehicle on the basis of the vehicle information of the candidate for the second vehicle and the vehicle information of the first vehicle associated to third unique information. When the candidate for the second vehicle is the second vehicle to be organized into a platoon with the first vehicle (step S140: YES), the process is advanced to step S150. When the candidate for the second vehicle is not the second vehicle to be organized into a platoon with the first vehicle (step S140: NO), the process is terminated.

At step S150, control section 3 performs a process of organizing a platoon.

Platoon vehicle determination apparatus 1 of the present embodiment includes storage section 5, vehicle detection section 32, vehicle acquiring section 31 and determination section 33. Storage section 5 stores the unique information of the third vehicle different from the first vehicle, and stores the vehicle information of the first vehicle in association with the unique information. Vehicle detection section 32 detects a vehicle having the same unique information as the unique information stored in storage section 5, from among surrounding vehicles in a region around the first vehicle, as a candidate for the second vehicle. Acquiring section 31 acquires vehicle information related to a candidate for the second vehicle detected by vehicle detection section 32. On the basis of the vehicle information of the candidate for the second vehicle acquired by acquiring section 31 and the vehicle information of the first vehicle stored in storage section 5 in association with the unique information of the third vehicle, determination section 33 determines whether the detected candidate for the second vehicle is the second vehicle to be organized into a platoon with the first vehicle. With this configuration, only some surrounding vehicles (candidates for the second vehicle) in a region around the first vehicle are required to be determined whether the vehicle is the second vehicle to be organized into a platoon with the first vehicle, and all surrounding vehicles in the region around the first vehicle are not required to be subjected to the determination, and thus, a platoon can be efficiently organized.

In addition, in platoon vehicle determination apparatus 1 of the present embodiment, the platoon vehicle determination process is started in response to an operation on operation section 4 by the user, and thus the user can organize a platoon at any timing regardless of whether it is before formation of a platoon or it is after release of a platoon.

Note that while control section 3 stores the unique information of the third vehicle in storage section 5 in response to an operation by the user in the present embodiment, the present disclosure is not limited to this, and control section 3 may store the unique information of the third vehicle in storage section 5 on the basis of a result of platooning. For example, in the case where the unique information of the third vehicle is stored in association with the vehicle information (the business operator name, the destination and the like) of the vehicle of the case where a platoon is organized, the unique information of the third vehicle is automatically stored in storage section 5. With this configuration, the convenience of the platooning can be improved.

In addition, while the platoon vehicle determination process is started when operation section 4 is operated by the user in the present embodiment, the present disclosure is not limited to this, and the platoon vehicle determination process may be started when a condition set in advance is satisfied, for example, when the engine of the first vehicle is started. With this configuration, the platoon vehicle determination process can be performed in a planned and automatic manner, and it is also possible to improve the convenience of the platooning.

In addition, in the present embodiment, even in the case where the destination of the candidate for the second vehicle is different from the destination of the first vehicle, determination section 33 may determine that the candidate for the second vehicle is the second vehicle to be organized into a platoon with the first vehicle when the distance of the same path and/or the travelling time on the same path is equal to or greater than a prescribed value. In this case, on the basis of travelling plans of the first vehicle and the candidate for the second vehicle, control section 3 calculates the distance of the same path and/or the travelling time of the same path. With this configuration, even in the case where the destination of the candidate for the second vehicle is different from the destination of the first vehicle, the candidate for the second vehicle can be organized into a platoon with the first vehicle, and thus improvement of fuel efficiency and the like can be achieved.

The above-mentioned embodiments are merely examples of the present disclosure, and the technical scope of the present disclosure should not be construed as limited by them. In other words, various modifications of the present disclosure may be made insofar as they are within the spirit and scope of the present disclosure.

This application is entitled to and claims the benefit of Japanese Patent Application No. 2018-163378 filed on Aug. 31, 2018, the disclosure each of which including the specification, drawings and abstract is incorporated herein by reference in its entirety.

### INDUSTRIAL APPLICABILITY

The platoon vehicle determination apparatus of the present disclosure is favorably utilized for vehicles that require efficient formation of platooning.

### REFERENCE SIGNS LIST

1 Platoon vehicle determination apparatus

2 Inter-vehicle communication section

3 Control section

4 Operation section

5 Storage section

31 Acquiring section

32 Vehicle detection section

33 Determination section

34 Setting section

1. A platoon vehicle determination apparatus configured to determine a second vehicle to be organized into a platoon with a first vehicle, the platoon vehicle determination apparatus comprising:
a storage section configured to store unique information of a third vehicle different from the first vehicle; and
a vehicle detection section configured to detect, as a candidate for the second vehicle, a vehicle having a same unique information as the unique information stored in the storage section from among surrounding vehicles in a region around the first vehicle.

2. The platoon vehicle determination apparatus according to claim 1, wherein the storage section stores the unique information of the third vehicle in association with vehicle information of the first vehicle.

3. The platoon vehicle determination apparatus according to claim 2, further comprising:
an acquiring section configured to acquire vehicle information related to the candidate for the second vehicle detected by the vehicle detection section; and
a determination section configured to perform a determination whether the candidate for the second vehicle is the second vehicle to be organized into the platoon on a basis of the vehicle information of the candidate for the second vehicle acquired by the acquiring section and the vehicle information of the first vehicle associated to the unique information of the third vehicle.

4. The platoon vehicle determination apparatus according to claim 3, further comprising a setting section configured to set the vehicle information used as a reference of the determination.

5. The platoon vehicle determination apparatus according to claim 1, further comprising a control section configured to perform a control of causing the vehicle detection section to detect the candidate for the second vehicle, through an operation by a user.

6. The platoon vehicle determination apparatus according to claim 1, further comprising a control section configured to perform a control of causing the vehicle detection section to detect the candidate for the second vehicle when a condition set in advance is satisfied.

7. A vehicle comprising the platoon vehicle determination apparatus according to claim 1.

8. A platoon vehicle determination method of determining a second vehicle to be organized into a platoon with a first vehicle, the method comprising:
storing unique information of a third vehicle different from the first vehicle; and
detecting, as a candidate for the second vehicle, a vehicle having a same unique information as the unique information that is stored from among surrounding vehicles in a region around the first vehicle.
